(19) United States
(12) Patent Application Publication
(10) Pub. No.: US 2024/0167523 A1
(43) Pub. Date: May 23, 2024

(54) Brake disc for a disc brake of a vehicle with a special design for reducing coning

(71) Applicant: HL MANDO CORPORATION, Pyeongtaek (KR)

(72) Inventor: Hatem Shahin, Pfaffenhofen (DE)

(21) Appl. No.: 18/363,818

(22) Filed: Aug. 2, 2023

(30) Foreign Application Priority Data
Nov. 23, 2022 (DE) 102022212511.8

(51) Int. Cl. F16D 65/12; F16D 69/02

(52) U.S. Cl. CPC F16D 65/123; F16D 65/125; F16D 65/127; F16D 65/128; F16D 69/027; F16D 2065/1344; F16D 2200/0013; F16D 2200/003

(57) ABSTRACT

The task of reducing the shielding or coning of a brake disc as a result of a temperature rise is solved by selecting a suitable material for the friction discs. The invention relates to a brake disc for a disc brake of a vehicle with a brake disc pot which has a pot base, a pot wall and an axis and with a friction disc unit, which is firmly connected to the wall and has two friction discs arranged parallel to one another in the form of a pot-side friction disc and a piston-side friction disc with friction surfaces which are arranged perpendicular to the axis (3), with the pot-side friction disc being closer to the bottom or base of the pot than the piston-side friction disc. In such a brake disc, it is provided that the piston-side friction disc consists at least partially of a material whose specific thermal expansion coefficient is lower than the thermal expansion coefficient of the pot-side friction disc.

### CROSS-REFERENCE TO RELATED APPLICATION

This application is based on and claims priority under 35 U.S.C. § 119 to German Patent Application No. 102022212511.8, filed on Nov. 23, 2022 in the German Patent and Trade Mark Office, the disclosures of which are incorporated herein by reference.

### TECHNICAL FIELD

The invention is applicable in the field of mechanical engineering and can be used with advantage in the manufacture and design of automotive components.

### BACKGROUND

For a long time, disc brakes have been used in automotive engineering to achieve large braking decelerations. Such disc brakes feature rotating brake discs or friction discs that are braked by drivable pistons held in a caliper which are carrying brake pads. The piston or pistons usually move perpendicular to the surface of the friction discs so that friction discs and the brake pads make frictional contact.

About 90% of the kinetic energy during a braking process of a vehicle is transformed into thermal energy and is subsequently dissipated via the brake discs. It is known that friction discs of disc brakes heat up during a braking process, for example up to 700 degrees Celsius or higher, whereby a reduction in braking power can occur not only due to changes in material properties changing friction conditions, but also due to deformation or distortion as a result of the temperature change. A typical case of this kind is so-called shielding or coning, in which thermal expansion can cause the friction disc and the whole brake disc to assume the shape of a section of a cone, because thermal expansion of the friction disc and its attachment to a brake disc pot can cause deformation of the pot.

Various documents are known from the prior art that deal with deformation problems of brake discs due to thermal expansion.

From document DE 10 2012 024011 B3, a particular geometric design of a brake disc is known which is intended to optimize its bending behavior and compensate for shielding of the friction ring.

DE 10 2012 010728 B3 discloses a geometrically specially shaped connection of a friction disc to the pot wall of a brake disc pot, the connection being made by receiving a spherical section of the friction disc in a connection receptacle of the pot wall. This is intended to allow the friction ring to move in the axial direction of the brake disc pot during thermal expansion.

From the document DE 10 2012 024298 A1, it is known that in a friction disc unit with two friction discs, these are provided on their sides facing each other with knobs which limit a range of movement of the two friction discs relative to each other during thermal expansion and in particular during a shielding or coning movement.

From the document DE 10 2013 001322 A1 a connection of a friction disc unit to the pot wall of a brake disc pot is known, in which by a plurality of connecting devices, which are distributed around the circumference of the brake disc unit, each provided with two areas of different surface finish, it is achieved that there is different play between the friction disc unit and the different areas of the wall of the respective connecting devices of the supporting part. This is intended to generate a counterforce that acts against a shielding of the friction ring.

From the document DE 10 2012 010729 A1, a casting manufacturing process for a disc brake is known, by which at first a friction ring is cast and then the cast friction ring is in a further process step merged in a second casting process with a supporting part of a brake disc pot.

Document DE 10 2012 024496 B3 describes a brake disc in which two friction rings of a friction ring unit are connected to a brake disc pot with different clearances in order to minimize shielding/coning.

Document DE4331683 A1 describes an internally ventilated brake disc in which ribs with rectangular cross-section are provided in the cooling ducts on the inner sides of the friction discs to dissipate heat.

### SUMMARY

Against the background of the prior art, the present invention is based on the task of creating a brake disc in which the shielding caused by thermal effects during braking is minimized or eliminated, as far as possible.

The solution of this task is achieved with the features of the invention according to patent claim 1.

The dependent claims indicate possible implementations of the invention.

Accordingly, the invention relates to a brake disc for a disc brake of a vehicle, having a brake disc pot which has a pot base, a pot wall and an axis of rotational symmetry, and having a friction disc unit which is fixedly connected to the pot wall and has a pot-side friction disc and a piston-side friction disc arranged parallel to one another with friction surfaces which are arranged perpendicular to the axis, the pot-side friction disc being closer to the pot base than the piston-side friction disc. To reach the goal of the invention, it is provided that the piston-side friction disc is at least partially composed of a material whose specific coefficient of thermal expansion is lower than the coefficient of thermal expansion of the pot-side friction disc.

On the one hand, in many cases when a two-piece friction disc unit is connected to a wall of a brake disc pot, the bending moment exerted on the pot wall by thermal expansion of the piston-side friction disc is greater than the bending moment exerted by the pot-side friction disc due to the longer lever arm of the piston-side friction disc. In the context of the current patent application, the pot-side friction disc could also be named a hub-side friction disc. The brake disc pot is also often called a brake disk hub or a hat or brake disc cup. In any account, the pot-side or hub-side friction disc is closer to the pot base of the brake disc pot than the piston-side friction disc. The piston side friction disc is located closer to the piston of the disc brake which is actively driven to press a brake pad against the piston-side friction disc.

Thus, a reduced force exerted by a lower thermal expansion of the piston-side friction disc is more significant than a reduction in the force exerted by thermal expansion of the pot/hub-side friction disc. In addition, the different coefficients of thermal expansion of the two friction discs create a deformation of the friction disc unit itself which is directed against the usual shielding or coning direction, which at least partially compensates for the shielding/coning created by the bending of the pot wall.

Typically, either the whole piston-side friction disc or at least one annular part or section of the piston-side friction disc can be made of a material whose specific coefficient of thermal expansion is lower than the coefficient of thermal expansion of the pot-side friction disc. For example, a ring made of a material having a lower coefficient of thermal expansion than the rest of the piston-side friction disc may be inserted into the piston-side friction disc. During production of the piston-side friction disc in the casting process, an annular part of this friction disc can also be provided with, for example, an alloy additive or a doping that results in a reduced coefficient of thermal expansion. In this way, the annular part of the piston-side friction disc designed in this way counteracts the thermal expansion of the other areas of this friction disc in the event of braking. The said annular part may for example be located at the radially inner edge of the piston-side friction disc.

It may also be provided as an implementation of the invention that at least one annular portion of the piston-side friction disc is made of a material whose specific coefficient of thermal expansion is lower than the coefficient of thermal expansion of the remaining portions of the piston-side friction disc. For example, the pot-side friction disc and the piston-side friction disc may be made of basically the same material, for example cast iron or gray cast iron, and an annular region may be provided in the piston-side friction disc whose coefficient of thermal expansion is lower than that of the pot-side friction disc and also lower than the coefficient of thermal expansion of the remaining regions of the piston-side friction disc. For example, an annular region of the piston-side friction disc or even the entire piston-side friction disc may be made of a cast iron containing vermicular graphite, while the pot-side friction disc is made substantially or entirely of a cast iron containing spheroidal graphite The coefficient of thermal expansion of cast iron containing vermicular graphite has a significantly lower thermal expansion, i.e. a lower coefficient of thermal expansion, than the cast iron containing only or predominantly spheroidal graphite, so that the shielding is counteracted by the construction described above.

Within the scope of the realization of the invention, it may also be provided that at least a part, in particular an annular part, of the piston-side friction disc consists of a material whose specific coefficient of thermal conductivity is greater than the coefficient of thermal conductivity of the pot-side friction disc.

This measure ensures that the heat from the piston-side friction disc is conducted more quickly to the connection to the brake disc hub than from the pot/hub-side friction disc. As a result, during the braking process or shortly after the braking process, heat transport can cause the piston-side friction disc to cool faster and to have a lower temperature than the pot-side friction disc, so that this measure also reduces the thermal expansion of the piston-side friction disc compared to the pot-side friction disc. This measure can also contribute to the minimizing of the shielding behavior of the brake disc.

In addition, according to the invention, it can be provided that the brake disc pot consists at least partially, in particular completely, of aluminum or an aluminum alloy. By designing the brake disc pot from aluminum or an aluminum alloy, the good heat conduction of the aluminum is used to transport and dissipate the heat generated in the friction disc unit as efficiently and quickly as possible from the friction disc unit via the connection to the brake disc pot. In many cases, the friction discs will be made of cast iron or gray cast iron, a material whose thermal conductivity coefficient is significantly lower than that of aluminum. In these cases, it is particularly important that the heat can be efficiently conducted away from the friction disc unit.

As already explained above, in order to implement the invention, it can be provided that the friction discs consist at least partially, in particular completely, of cast iron or one or more cast iron alloys or grey cast iron.

It can also be provided, for example, that the pot-side friction disc is directly connected to the pot wall and that the radially inner region of the piston-side friction disc is connected to the pot wall by means of the pot-side friction disc.

In such a case, the heat occurring in the piston-side friction disc would be conducted to the pot wall via the radially inner region of the pot-side friction disc. Therefore, it is particularly important that, despite the high temperature of the friction disc on the piston side, the thermal expansion of this piston-side friction disc is limited by choosing the lowest possible coefficient of thermal expansion.

In a further embodiment, it can be provided that both the pot-side friction disc and the piston-side friction disc are firmly connected directly to the pot wall.

With this design, the heat can be conducted directly from the piston-side friction disc to the pot wall, without a detour via the material of the piston-side friction disc. This efficient heat dissipation can make an additional contribution to limiting the thermal expansion of the piston-side disc.

In a further embodiment, it can also be provided that both the friction disc on the pot side and the friction disc on the piston side are each connected to a common attachment device or attachment element, in particular a common attachment ring or connecting ring, which in turn is firmly connected to the wall.

In this case, an even heat dissipation from both friction discs to the wall of the brake disc is ensured, whereby the acting thermal expansion forces of the two friction discs are already brought together and combined in the common attachment device, which means, for example, the effect of a longer lever arm of the friction disc on the piston side compared to the lever arm of the forces acting through the pot-side friction disc is reduced. In this latter case, an independent deformation of the friction disc unit itself can occur due to different thermal expansion of the two friction discs. In addition, a resulting force of the friction disc unit as a whole is generated that acts through the attachment device on the brake disc pot due to the thermal expansion of the two friction discs, wherein the deformation of the friction disc unit per se can counteract against and partially compensate for the deformation of the brake disc pot.

### BRIEF DESCRIPTION OF DRAWINGS

The invention is further explained in detail in exemplary embodiments below with reference to figures of a drawing.

Therein:

FIG. 1 shows a brake disc with a brake caliper, in which a piston is guided, in a partially sectioned side view,

FIG. 2 shows the brake disc from FIG. 1 in a front view,

FIG. 3 shows part of a brake disc with two friction discs in a side view,

FIG. 4 shows the representation of FIG. 3 under the effect of thermal expansion,

FIG. 5 shows part of a brake disc in a side view with a connection of the friction disc unit to the pot wall that differs from the connection in FIGS. 3 and 4,

FIG. 6 shows a friction disc unit with friction discs of different sizes for designing/optimizing the heat conduction conditions,

FIG. 7 shows a friction disc unit with additional thermal bridges between the friction discs to optimize heat dissipation from the piston-side friction disc,

FIG. 8 shows a part of the section of FIG. 7 inside the cercle in a special view,

FIG. 9 shows a design similar to FIG. 7 with a connection of the friction disc unit to the brake disc pot that differs from FIG. 7,

FIG. 10 shows a representation of the piston-side friction disc in a front view with an annular area made of a material with a reduced coefficient of thermal expansion,

FIG. 11 shows an embodiment of a brake disc in which the two friction discs are connected to the pot wall with a common connection device,

FIG. 12 shows a cross-sectional view according to the dotted line A-A in FIG. 11,

FIG. 13 shows a brake disc unit with fins for the internal ventilation wherein the fins carry extensions which have more thermal contact to the piston-side friction disc than to the pot-side friction disc,

FIG. 14 shows a cross-sectional view according to the dotted line XIII-XIII in FIG. 13,

FIG. 15 shows a cross-sectional view according to the dotted line XIV-XIV in FIG. 13,

FIG. 16 shows a cross-sectional view according to the dotted line XV-XV in FIG. 13, and

FIG. 17 shows a side view of the piston-side friction disc, where the different annular regions of the piston-side friction disc are denoted.

### DETAILED DESCRIPTION

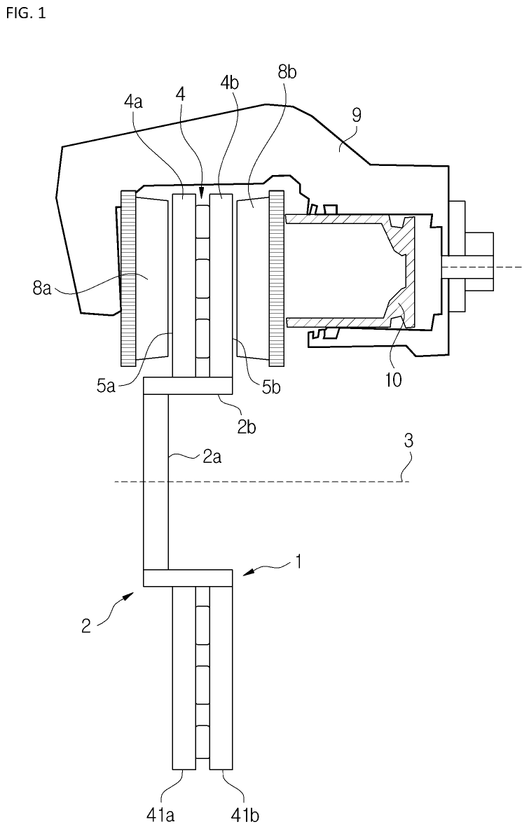

FIG. 1 shows a partially sectioned side view of a brake disc 1 with a brake disc pot 2 which is arranged symmetrically around an axis 3, the brake disc pot 2 having a pot bottom or pot base 2a on the one hand and a pot wall 2b on the other. The pot bottom/base 2a can be designed to be circular and flat, and the pot wall 2b can extend perpendicularly and cylindrically symmetrically from the pot bottom/base 2a. However, the pot wall 2b can also expand for example conically from the bottom of the pot. A friction disc unit 4 is firmly connected to the pot wall 2b, the friction disc unit having a pot-side friction disc 4a and a piston-side friction disc 4b. The two friction discs can be connected to one another, for example by ribs forming between them ventilation channels, as a result of which an internally ventilated brake disc unit is formed. The two friction discs 4a, 4b have friction surfaces 5a, 5b on their outside, which come into frictional contact with the brake pads 8a, 8b during braking. The brake pads are basically held in a brake caliper 9, with the pot-side brake pad 8a being arranged stationary, while the piston-side brake pad 8b is attached to a piston which can be driven in the direction parallel to the axis 3. The gaps between the brake pads 8a, 8b and the friction surfaces 5a, 5b are small, so that when the piston 10 travels only a short distance, the piston is pressing the piston-side brake pad against the friction disc unit and the friction disc unit against the pot-side brake pad, thereby generating frictional forces which lead to delaying the rotation of the brake disc 1. A prerequisite for efficient braking behavior and unimpeded freewheeling of the brake disc outside of braking processes is a stable alignment of the friction surfaces 5a, 5b and thus the friction discs 4a, 4b perpendicular to the axis 3. Deviations from such a desirable alignment can be generated for example by uneven wear on the friction surfaces 5a, 5b or on the brake pads 8a, 8b, as well as by deformation or distortion of the friction discs or the whole brake disc, for example due to thermal influences, as described in more detail below.

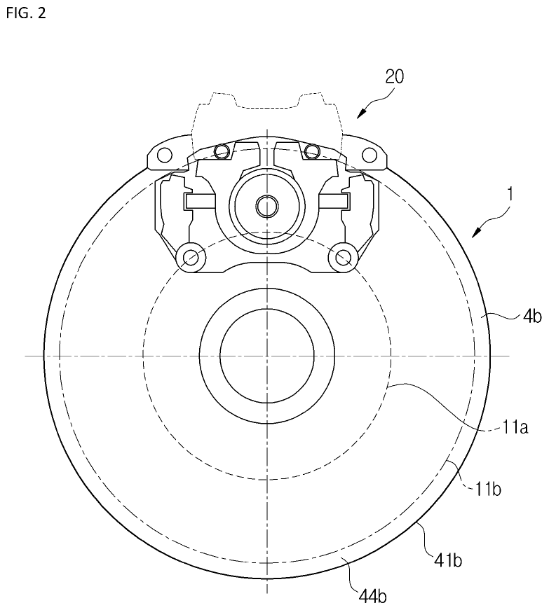

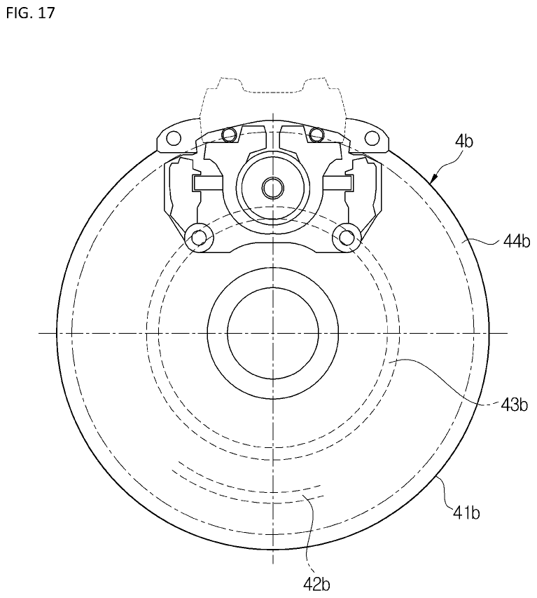

FIG. 2 shows a disc brake as already shown in FIG. 1 in a side view. The friction surfaces that actually come into contact with the brake pads 8a, 8b are located between the dashed circle lines 11a and 11b. In this FIG., also a third annular region 44b of the friction disc is denoted which is located near the radially outer edge 41b of the friction disc 4b. The third annular region 44b is further described in connection with FIG. 17.

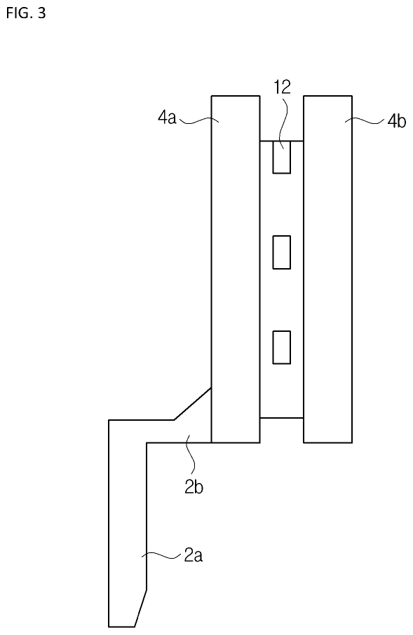

A part of a brake disc is shown schematically in FIG. 3, where a part of the base 2a of the brake disc pot and part of the pot wall 2b are visible. The friction disc unit 4, 4a, 4b is fastened to the pot wall 2b, connecting webs or ribs 12 being provided between the two friction discs 4a, 4b, which form radially aligned compartments between the friction discs, whereby in the course of the rotation of the disc active ventilation is generated. Air that enters radially on the inner side between the friction discs 4a, 4b near the axis 3 is transported radially outwards by centrifugal forces during the rotation of the brake disc, and this actively promotes an air flow that serves to cool the friction discs.

The webs/ribs 12 therefore may also be called ventilation webs/ribs, but they also stabilize the friction disc unit by firmly connecting the two friction discs 4a, 4b to one another. For this purpose, the webs 12 can, for example, be cast together with the friction discs or can be connected to the friction discs in a joining process. The webs usually form walls reaching from one friction disc to the other and connecting the friction discs fixedly with one another.

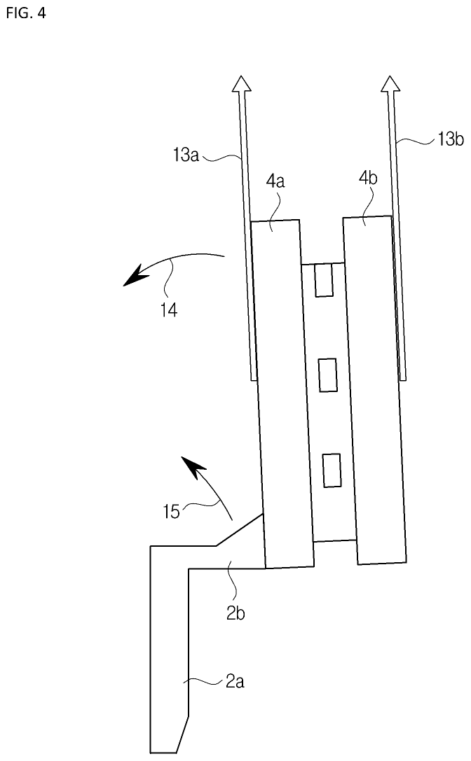

FIG. 4 shows the constellation of the components from FIG. 3 for the case of a high temperature of the friction discs 4a, 4b. If the friction discs are heated by the effect of friction with the brake pads during braking, the material of the friction discs, which are often made of cast iron, for example gray cast iron, expands thermally, causing the friction discs to expand radially overall. However, since the friction discs are firmly connected to the pot wall 2b, the widening of the friction discs, which have the form of rings, has an effect on the connection to the brake pot wall. Both friction discs generate an expanding movement in the direction of the arrows 13a, 13b and thus a force in the direction of these arrows on the wall 2b. The pot wall 2b can bend elastically, which results in shielding or coning of the brake disc and tilting of the friction disc unit 4 counterclockwise, as shown in the figure. The tilting or shielding of the friction disc unit is shown by arrow 14, the bending of the wall 2b by arrow 15. The radial expansion of friction disc 4b on the piston side has a greater effect on the pot wall than an equally large expansion of the pot-side friction disc due to the longer lever arm of friction disc 4a with regard to the bending point or bending area of the pot wall. The lever arms are shown in detail in FIG. and are described in more detail below.

The described shielding or coning of the friction disc unit means that the friction surfaces 5a, 5b of the friction discs no longer lie flat on and parallel to the surfaces of the brake pads 8a, 8b, so that the braking effect is reduced and uneven wear of the brake pads and friction discs is caused. For this reason, the deformation of the pot wall and the friction disc unit shown in FIG. 4 should be avoided or minimized as far as possible.

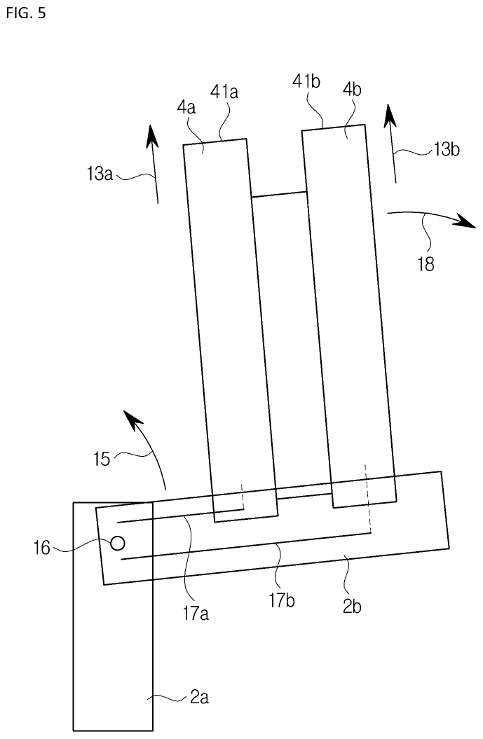

FIG. 5 basically shows a similar design of a brake disc as FIGS. 3 and 4, although the connection of the friction discs 4a, 4b to the pot wall 2b is designed differently than in the exemplary embodiment of FIGS. 3 and 4. FIG. 5 clearly shows the bending of the pot wall 2b radially outwards in the direction of the arrow 15, with the inclination angle of the friction discs 4a, 4b primarily resulting from this bending of the pot wall 2b. According to FIG. 5, each of the two friction discs 4a, 4b is connected to the pot wall 2b by a separate firm connection, so that the forces generated by the friction discs 4a, 4b in the direction of the arrows 13a, 13b in the event of a thermal expansion, are each transferred directly to the pot wall 2b. If one assumes as a model a deformation of the wall 2b by a tilting movement about the axis 16, the bending moment exerted by the two friction discs 4a, 4b is different. The lever arm 17b is significantly longer than the lever arm 17a. Therefore, the effect of the lever arm 17a of friction disc 4a on a bending of the pot wall is smaller, while the contribution of the friction disc 4b on a bending of the pot wall by the longer lever arm 17b is bigger. As a consequence, a reduction in the thermal expansion of the friction disc 4b, i.e. the piston-side friction disc, during the braking process results in a greater reduction in the bending of the wall 2b than if the expansion of the pot-side friction disc 4a were reduced to the same extent. A minimization of the shielding of the brake disc shown can therefore start particularly efficiently by influencing and reducing the thermal expansion of the piston-side friction disc 4b. For this reason, it is an object of the invention to use a material for the piston-side friction disc 4b whose thermal expansion coefficient is lower than the thermal expansion coefficient of the material of which the pot-side friction disc 4a consists. This can also be achieved when at least parts of the piston-side friction disc 4b consist of such a material with a reduced coefficient of thermal expansion.

For example, the friction disc 4b on the piston side can be made entirely or partially, for example in a ring-shaped area of the friction disc 4b, from a cast iron with vermicular graphite, while the friction disc on the pot side is made from a cast iron with spherical graphite. The addition of vermicular graphite means that this type of cast iron has a significantly lower coefficient of thermal expansion than cast iron with spherical graphite.

Another effect of an embodiment in which the friction disc 4b on the piston side has less thermal expansion than the friction disc 4a on the pot side is that the friction disc unit itself in the case of rising temperatures experiences a distortion in the direction of arrow 18 due to the fixed connection between the two friction discs. This deformation/distortion of the friction disc unit counteracts the tilting movement of the friction disc unit as a result of a bending of the pot wall 2b, so that this effect also contributes to the minimization of the shielding of the brake disc and thus reduces the overall shielding.

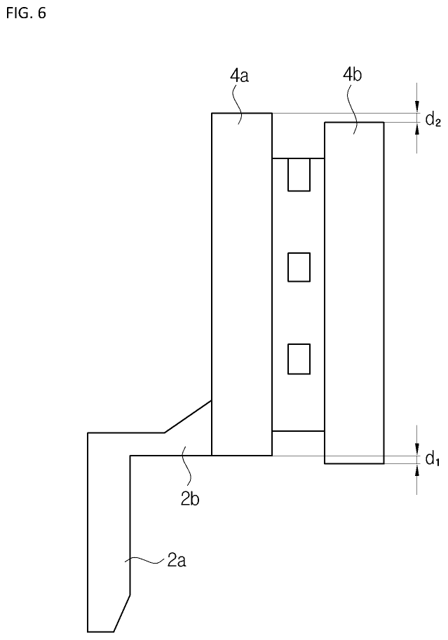

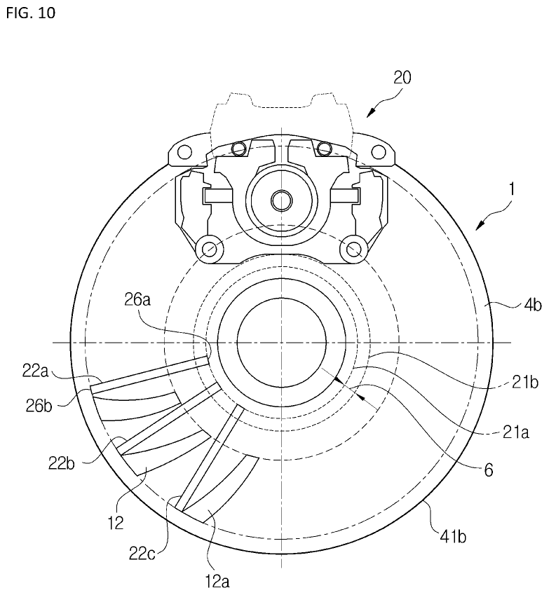

FIG. 6 shows a construction in which the pot-side friction disc 4a is directly mechanically connected to the pot wall 2b, i.e. firmly connected to it, while the piston-side friction disc 4b is connected through the pot-side friction disc 4a with the pot wall 2b. In the embodiment of FIG. 6, the inner diameter of the friction disc 4b on the piston side is smaller by the amount d1 than the inner diameter of the friction disc 4a on the pot side. Due to the smaller dimensions of the piston-side friction disc, this effect alone can bring about a smaller widening of the piston-side friction disc when the same temperature increase of both friction discs occurs. Alternatively or additionally, the outer diameter of the piston-side friction disc 4b can also be selected to be smaller by the amount d2 than the outer diameter of the pot-side friction disc 4a in order to reduce the effect of thermal expansion. d1 and/or d2 could be chosen to be bigger than 0.4 mm and/or smaller than 0.8 mm, for example in the range of 0.6 mm. For all cases, that is, a smaller inner and/or outer diameter of the piston side friction disc compared to the pot-side friction disc or equal inner and outer diameters of both discs, it may also be provided as an additional measure that the thickness of the piston-side disc is slightly bigger that the thickness of the pot-side disc. For example, the piston-side disk may be at least 1% or 2% or at least 3% thicker in axial direction than the pot-side disc. However, generally, it is a goal to avoid adding mass to the friction rings. Therefore, it could be provided to leave the mass of the piston side friction disc unchanged and at the same value as the mass of the pot-side friction disc, but reduce its overall thickness a little while adding at the same time radial heat transport ribs 22a, 22b (conf. FIG. 10) on the surface of the piston-side friction disc which faces the pot-side friction disc. By this measure, without a change of the thermal and kinetic mass, the heat transport in radial direction of the piston-side disc would be improved by the heat transport ribs. The heat transport ribs should be provided in addition to the ribs which connect the two friction discs and form fins 12 for the internal ventilation of the brake disc unit. The ribs and fins are shown in more detail in FIG. 10. This measure can provide a better thermal contact of the piston-side friction disc to the pot wall 2b than the thermal contact of the pot-side friction disc to the pot wall. By choosing a slightly bigger thickness of the piston-side friction disc than of the pot-side friction disc, the thermal capacity of the piston-side friction disc would be enlarged so that the temperature rise of this disc in case of a braking action may be lower than the temperature rise in the pot-side friction disc.

One additional potential measure could also provide that the coefficient of specific heat capacity of the material used for the piston-side friction disc could be higher than the coefficient of specific heat capacity or thermal capacity of the material used for the pot-side friction disc. This would also lead to a smaller temperature rise on the piston side than on the pot side in case of a thermal load by a braking process.

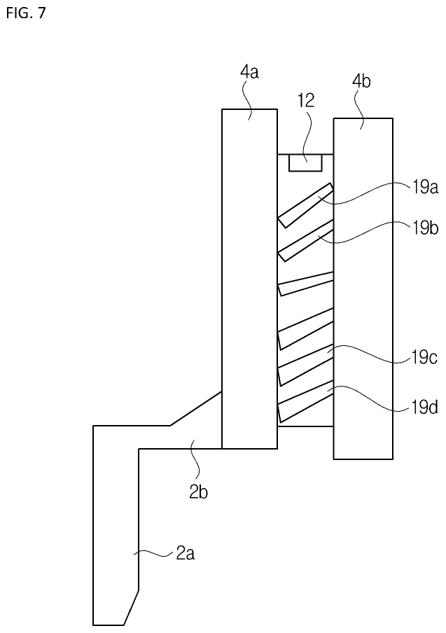

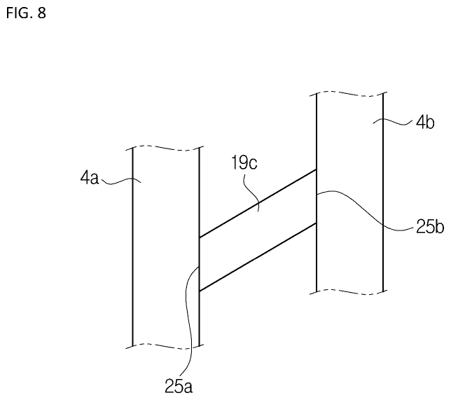

FIG. 7 shows a construction similar to that shown in FIG. 6, wherein the piston-side friction disc 4b is thermally connected to the pot wall 2b with the lowest possible thermal resistance. Thermal bridges are formed by strand-shaped heat-conducting bodies 19a, 19b, 19c, 19d between the two friction discs 4a, 4b, for example, by rods or pistons which can be connected to the webs/ribs 12 forming fins for the internal ventilation of the brake disc, or by other bodies with good thermal conductivity, so-called heat-conducting bodies, which each lead from a radially further outward area of the piston-side friction disc 4b to a radially inner area of the pot-side friction disc 4a. In other words, each of the heat-conducting bodies which are provided to form additional thermal bridges between the pot-side friction disc and the piston-side friction disc, are in contact with the piston-side friction disc through a first contact area 25b and in contact with the pot-side friction disc through a second contact area 25a, wherein all or at least the major part of the second contact area of each body has a smaller distance from the axis 3 and/or from the pot wall 2b than the first contact area of the same body. Thus, it can be provided that the centroid or geometric centroid, also known as geometric center of the second contact area 25a of each heat-conducting body is located closer to the axis 3 than the centroid/geometric centroid/geometric center of the first contact area 25b of the same heat-conducting body, as is shown in more detail in FIG. 8, which shows a section of FIG. 7, represented in FIG. 7 inside the cercle.

As an overall consequence, the radially outer regions of the friction disc 4b are, by the effect of the heat-conducting bodies 19a, 19b, 19c, 19d, thermally better and with smaller thermal resistance connected to the radially inner regions of the friction disc 4a and thus to the wall 2b than the radially outer regions of the pot-side friction disc 4a. This means that the heat which is generated by a braking process can be better dissipated from the piston-side friction disc 4b to the wall 2b than from the pot-side friction disc 4a, which means that during the braking process and also afterwards in the cooling phase, heat is dissipated better from the piston-side friction disc 4b than from of the pot-side friction disc 4a. As a consequence, an overall lower temperature of the piston-side friction disc 4b can be realized. The pot wall, like the pot bottom or base 2a of the brake pot, can be made of aluminum, which has a higher heat conduction coefficient and thus better heat conduction than, for example, the cast iron of the friction discs.

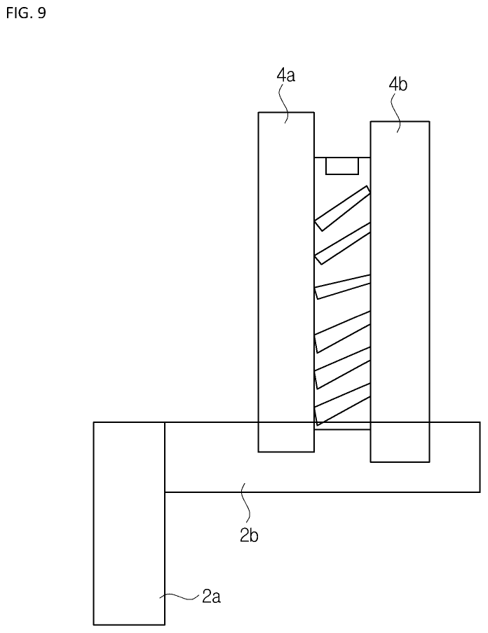

In FIG. 9 it is shown that with a direct and immediate connection of both friction discs 4a, 4b to the wall 2b, particularly when the inner diameter of the piston-side friction disc is smaller than the inner diameter of the pot-side friction disc, a more efficient thermal connection of the piston-side friction disc to the pot wall succeeds than is the case with the pot-side friction disc 4a. The radially inner area of the piston-side friction disc 4b can be in direct contact with the highly thermally conductive material of the pot wall 2b to a greater extent than is the case with the pot-side friction disc 4a.

FIG. 10 shows a brake disc with a brake caliper 20 in a front view, the brake disc being denoted overall by 1 and a friction disc by 4b. An annular area 6 is marked on the friction disc 4b between the two dashed lines 21a and 21b, the material of the area 6 as an example having a lower specific thermal expansion coefficient than the other areas of the friction disc 4b. As a result, the transmission of a thermal expansion in the outer areas of the friction disc 4b to the radially inner wall 2b of the brake disc is reduced. The annular area 6 can be located in the inner half of the friction disc 4b, for example, immediately adjacent to the wall 2b.

The expansion coefficient of the material of the piston-side friction disc or of a part of it can be, for example, 0.8×10-5 per Kelvin or 0.85×10-5 per Kelvin or 0.9×10-5 per Kelvin. The material of the pot-side friction disc can then have a specific thermal expansion coefficient of, for example, 1×10-5 per Kelvin or 1.2×10-5 per Kelvin. In principle, it can be advantageous if the material of the piston-side friction disc or an annular area of the piston-side friction disc has a thermal expansion coefficient that is at least 10%, in particular at least 15% or at least 20% smaller than the specific thermal expansion coefficient of the pot-side friction disc. The annular area 6 with a reduced coefficient of thermal expansion compared to the rest of the friction disc can be arranged radially inward, for example on the inner edge of the ring-shaped friction disc, but also in the central area or in the radially outer area, in particular on the outer edge 41b of the friction disc.

In FIG. 10, in addition to fins 12, 12a for the internal ventilation of the brake disc unit, some protrusions in the form of strand-shaped ribs or webs 22a, 22b, 22c are provided on the inner surface of the piston-side friction disc 4b, which faces the pot-side friction disc 4a. Each rib or web is protruding from the friction disc in axial direction and has, in its radial extension in the plane parallel to the surface of the friction disc, two ends 26a, 26b, a first end 26a of its longitudinal extent being located radially closer to the axis 3 of the brake disc pot 2 (not represented in FIG. 10) than the second end 26b. The pot-side friction disc has no such ribs or webs or, if it has such elements, the cross section area of each single rib and/or their sum is smaller than respective cross section areas on the side of the piston-side friction disc. In FIG. 10, as an example, some straight heat transport ribs 22a, 22b, 22c are shown, but they may as well be curved. Heat transport webs/ribs or the direction of their longest extension can be aligned at least partially to a radial direction or the heat transport webs/ribs can extend strictly radially or for example in an angle deviating less than 30 degrees from the radial direction. The heat transport ribs can for example have no or minimal thermal contact to the pot-side friction disc or if they have thermal contact to the pot-side friction disc, then it is preferably at their ends which are located closer to the axis 3 than the other ends.

The heat transport ribs can e.g., consist of the same material as the friction discs 4a, 4b and can, e.g., be cast in one single casting process with them.

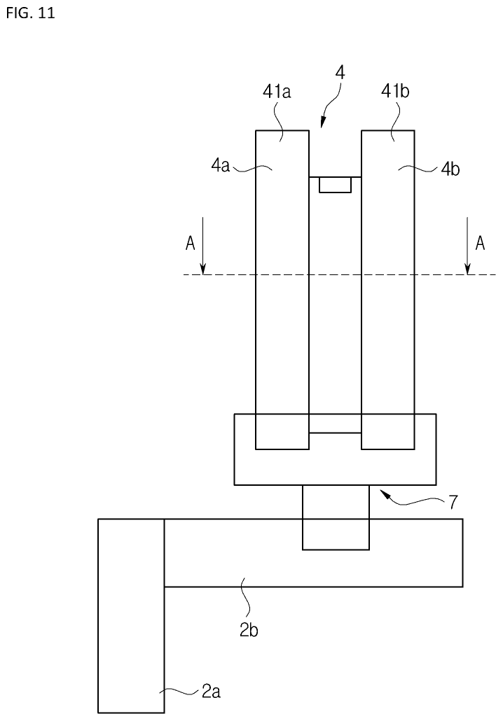

FIG. 11 shows a schematic of a structure of part of a brake disc, in which a friction disc unit 4 is connected to a wall 2b in such a way that two individual friction discs 4a, 4b are each directly connected to or partially embedded in an attachment device formed by a connecting ring 7, which is formed in this concrete case as a solid metal ring which in turn is integrally connected to or partially embedded in the pot wall 2b. For example, the two friction discs can each be cast separately in the ring 7, which is either glued, soldered or joined to the wall or cast integrally together with the wall 2b. It could as well be provided that the connecting ring is formed as a ring with several pistons distributed on its radial inner side around the circumference pointing radially inward, wherein the pistons are each anchored in the pot wall 2b.

In this configuration too, the piston-side friction disc 4b can have a lower coefficient of thermal expansion overall or in part than the pot-side friction disc 4a. In addition, as already shown in FIGS. 7 and 9, thermal bridges can also be provided between the piston-side friction disc 4b and the connecting ring 7 or between the piston-side friction disc 4b and radially inner parts of the pot-side friction disc in order to make the heat transport between the piston-side friction disc 4b and the connection ring 7 more effective than the heat transport from the pot-side friction disc 4a to the connection ring 7.

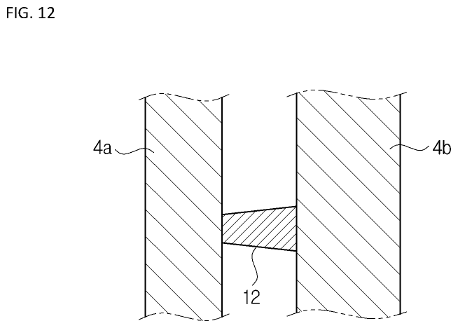

In FIG. 12, a cross sectional view is shown as indicated in FIG. 11 by the dotted line A-A. It can be seen that the web or rib 12 has a cross section with a bigger contact surface to the piston-side friction ring than the contact surface to the pot-side friction disc. This can for example be achieved by a trapezoidal cross section of the ribs 12. That means that along the length of the ribs or at least some of the ribs, at least in the majority of their length in each cross sectional view the contact line between the ribs and the piston-side friction disc is longer than the contact line between the same rib and the pot-side friction disc in the same cross-sectional view.

By this measure, the cross section of the ribs adds itself mainly to the cross section of the piston-side friction disc and supports the transport of heat/thermal energy from the piston-side friction disc in radial direction to the pot wall 2b.

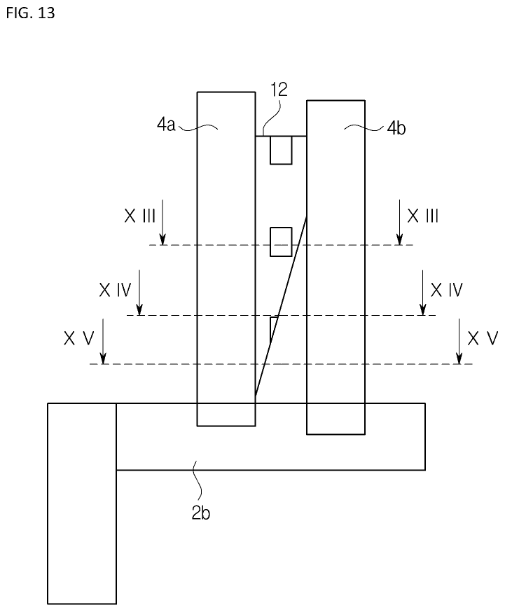

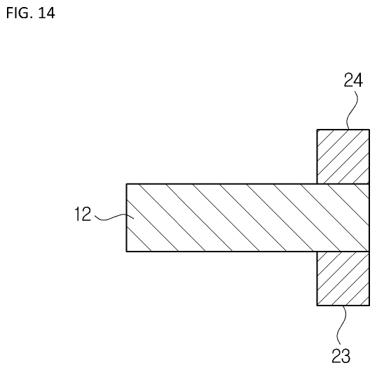

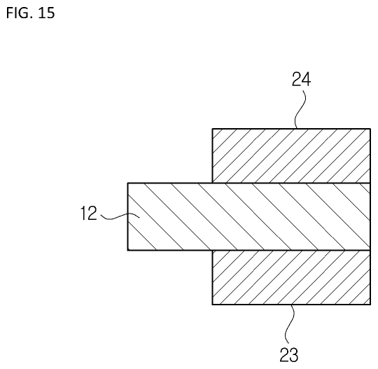

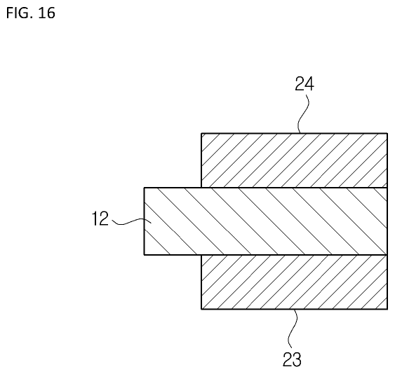

FIG. 13 shows a brake disc unit with a piston-side friction disc 4b and a pot-side friction disc 4a, wherein the radial inner sides of the friction discs are both embedded in the pot wall 2b. Further, fins 12 for the internal ventilation are shown wherein the fins 12 carry extensions or heat-conducting bodies 23, 24 which have more thermal contact to the piston-side friction disc than to the pot-side friction disc. The extensions 23, 24 can also be considered as ribs or webs which protrude from the surface of the piston-side friction disc 4b and at the same time, are in contact with the fins 12. In the example shown in FIG. 13, the extensions 23, 24 have a triangular shape with the base of the triangle being located on the pot wall 2b. The extensions are connected to the fins 12 and to the piston-side friction disc so that they add heat conducting capacity to the friction disc 4a. The extensions 23, 24 above all serve to transport heat in radial direction from the friction disc 4a to the pot wall 2b. FIGS. 14, 15 and 16 are representing cross-sectional views which show that the cross section of the extensions 23, 24 is growing from their radially outer end to their radially inner end/towards the pot wall 2b, where they have to transport more heat than in the radially outer regions. Thereby, the mass added to the friction disc by the extensions is minimized.

In FIG. 17, a side view of the piston-side friction disc is shown, where the different annular regions 42b, 43b, 44b of the piston-side friction disc are shown. It has to be noted, that each of the first, second and third annular regions on the pot-side friction disc has the same inner and outer diameters as the respective regions of the piston-side friction disc. The radially outer edge of the piston-side friction disc is denoted as 41b.

According to one implementation of the invention, it may be provided that the thermal resistance between the radially outer edge 41b of the piston-side friction disk 4b and the pot wall (not shown in FIG. 17) is lower than the thermal resistance between the radially outer edge 41a of the pot-side friction disk 4a and the pot wall.

As already explained above, it may also be provided, that the thermal conduction resistance between a first annular region 42b and/or a second annular region 43b and/or a third annular region 44b of the piston-side friction disc on one hand and the pot wall on the other hand is less than the thermal conduction resistance between the respective of the annular regions of the pot-side friction disc and the pot wall.

Therein, according to the shown example, the internal diameter of the first annular region 42b corresponds to the center of the annular region of the friction discs which comes into contact with the brake pads 8a, 8b during a braking operation.

The inner diameter of the second region 43b corresponds to the radially inner diameter of the annular region of the friction discs which comes into contact with the brake pads 8a, 8b during a braking operation.

The third annular region 44b is located adjacent to the radially outer edge 41b of the piston-side friction disc.

The measures described above make it possible overall to reduce the thermal expansion of a piston-side friction disc compared to the thermal expansion of a pot-side friction disc, so that the overall shielding of the brake disc 1 is reduced or prevented.

What is claimed is:

1. Brake disc for a disc brake of a vehicle, having a brake disc pot which has a pot base, a pot wall and an axis of rotational symmetry, and having a friction disc unit which is fixedly connected to the pot wall and has a pot-side friction disc and a piston-side friction disc arranged parallel to one another with friction surfaces which are arranged perpendicular to the axis, the pot-side friction disc being closer to the pot base than the piston-side friction disc, characterized in that the piston-side friction disc is at least partially composed of a material whose specific coefficient of thermal expansion is lower than the coefficient of thermal expansion of the pot-side friction disc.

2. Brake disc according to claim 1, characterized in that at least one annular part of the piston-side friction disc consists of a material whose specific coefficient of thermal expansion is lower than the coefficient of thermal expansion of the pot-side friction disc.

3. Brake disc according to claim 1, characterized in that at least one annular part of the piston-side friction disc consists of a material whose specific coefficient of thermal expansion is lower than the coefficient of thermal expansion of the remaining areas of the piston-side friction disc.

4. Brake disc according to claim 1, characterized in that at least a part, in particular an annular part, of the piston-side friction disc consists of a material whose specific coefficient of thermal conduction is greater than the coefficient of thermal conduction of the pot-side friction disc.

5. Brake disc according to claim 1, characterized in that at least a part, in particular an annular part, of the piston-side friction disc consists of a material whose specific heat conduction coefficient is greater than the heat conduction coefficient of the remaining areas of the piston-side friction disc.

6. Brake disc according to claim 1, characterized in that the brake disc pot consists at least partially, in particular completely, of aluminum or an aluminum alloy.

7. Brake disc according to claim 1, characterized in that the friction discs consist at least partially, in particular completely, of cast iron or one or more cast iron alloys.

8. Brake disc according to claim 1, characterized in that the pot-side friction disc is firmly connected directly to the pot wall and that the radially inner region of the piston-side friction disc is connected to the pot wall by means of the pot-side friction disc.

9. Brake disc according to claim 1, characterized in that both the pot-side friction disc and the piston-side friction disc are firmly connected directly to the pot wall.

10. Brake disc according to claim 1, characterized in that both the pot-side friction disc and the piston-side friction disc are each connected to a common connecting device, in particular a common connecting ring, which in turn is firmly connected to the pot wall.
